(19) United States
(12) Patent Application Publication
(10) Pub. No.: US 2011/0267718 A1
(43) Pub. Date: Nov. 3, 2011

(54) MAGNETIC RECORDING MEDIUM AND METHOD OF MANUFACTURING THE SAME

(75) Inventors: Akihiro ITAKURA, Akishima-shi (JP); Akira KIKITSU, Yokohama-shi (JP); Yoshiyuki KAMATA, Tokyo (JP); Naoko KIHARA, Kawasaki-shi (JP)

(73) Assignee: KABUSHIKI KAISHA TOSHIBA, Tokyo (JP)

(21) Appl. No.: 13/070,376

(22) Filed: Mar. 23, 2011

(30) Foreign Application Priority Data
Apr. 28, 2010 (JP) 2010-104338

(51) Int. Cl. G11B 5/82; G11B 5/84

(52) U.S. Cl. 360/135; 216/22; G9B/5.293

(57) ABSTRACT

According to one embodiment, a magnetic recording medium includes a plurality of magnetic dots having a pattern formed by self organization. The density of magnetic dots in a peripheral portion of a central portion in a widthwise direction is higher than that of magnetic dots in the central portion at a burst portion of the magnetic recording medium.

### CROSS-REFERENCE TO RELATED APPLICATIONS

This application is based upon and claims the benefit of priority from Japanese Patent Application No. 2010-104338, filed Apr. 28, 2010; the entire contents of which are incorporated herein by reference.

### FIELD

Embodiments described herein relate generally to a magnetic recording medium and a method of manufacturing the same.

### BACKGROUND

Recently, a thermal decay phenomenon by which recording marks disappear at room temperature poses a problem when increasing the recording density of a magnetic recording medium of a hard disk drive. A bit patterned medium, in which data are recorded in physically divided magnetic dots, has been proposed as a high-density magnetic recording medium capable of suppressing such phenomenon.

As an inexpensive manufacturing process of the bit patterned medium, a nano-imprint lithography, that duplicates a large amount of patterns into a resist layer on the medium, has been developed. Manufacturing a master template for the duplication is the key technology for the nano-imprint lithography. The bit patterned medium is anticipated as a high-density magnetic recording medium exceeding 2 Tbpsi (2 Terabit pitch per square inch), where the period between magnetic material dots are 20 nm or less. Accordingly, the medium requires ultrafine patterns, which are difficult to form by the current photolithography technique used in the field of the semiconductor process or the optical disk mastering process. Recently, a master template for a bit patterned medium has been developed by using electron-beam lithography. Unfortunately, electron-beam lithography has serious problems, i.e., a low throughput and a low resolution due to the proximity effect or the like.

Self-organizing phenomena of a diblock copolymer has capability of inexpensively forming fine patterns of a few nm to a few ten nm by using a micro phase separation structure (e.g., a lamellar structure, a cylinder structure, or a sea-island structure). An imprinting master can be manufactured by etching a substrate through a mask made of this self-organizing structure. However, to manufacture a bit patterned medium master by using this method, the self-organizing pattern must be form a specific layout that enables recording and reproduction operation for a hard disk drive.

As a method of forming a self-organizing structure to a specific structure, a method of preforming a desired physical guide groove and forming a dot as a micro phase separation structure in the groove has been proposed. When a sea-island self organizing structure is formed in a concentric groove structure, the island portion can be used as a dot of a master template for a data area of the bit patterned medium. In the guide groove, the dot array takes a hexagonal close-packed structure. In order to allow this bit patterned medium to have a function of a magnetic recording medium, it is also necessary to form a pattern of a servo signal area, in which information of the relative position of a recording/reproduction head and the track central position, track data information, and sector data information are embedded. The servo area includes a preamble portion for generating a sync signal, an address portion containing sector information and cylinder information, and a burst portion for obtaining a positioning signal. This servo area requires not a simple linear groove but a complicated guide structure corresponding to each signal characteristic.

The preamble portion is an essential area for obtaining a sync signal for signal recording and reproduction. If the signal quality of this area is poor, it is impossible to input a reproduction signal to a PLL (Phase Locked Loop) and generate a reproduction clock signal. The address portion is an essential area for obtaining, e.g., the cylinder number of the data area. If the signal quality of this area is poor, it is impossible to search for (seek) a desired data area during recording/reproduction. In the present hard disk magnetic recording medium, a magnetic layer is formed on a flat disk substrate such as glass, and a continuous magnetic material mark is formed as a servo signal mark from the inner circumference to the outer circumference by using a servo writer apparatus or the like. The width of this servo signal mark in the disk circumferential direction continuously increases from the inner circumference toward the outer circumference, because the hard disk drive uses the CAV (Constant Angular Velocity) method in which the rotational angular velocity is constant during mark recording/reproduction. The bit patterned medium can be manufactured by forming the above-described servo signal pattern on the medium. When manufacturing the bit patterned medium by self-organizing lithography, therefore, the servo portion must be formed by using a self-organizing pattern in the same manner as for the data portion. That is, the servo signal area pattern is formed by preforming a guide groove in a prospective servo signal pattern area as a present magnetic recording medium, and forming a self-organizing pattern in the groove. The preamble portion and the address portion can be formed by forming a guide groove extending from the inner circumference to the outer circumference. The groove width gradually changes from the inner circumferential side to the outer circumferential side. Since the number of self-organized dot rows is determined by the guide width, it changes discontinuously with radius. This makes it very difficult to obtain a high SNR (Signal to Noise Ratio) signal from the preamble region. A magnetic recording medium manufactured using this method has a problem that there is a portion where defects of the alignment of the self-organizing magnetic dots occur, which depends on the radial position, and the signal quality degrades. This results in the poor recording/reproduction operation of the HDD. Also, the packing density of the magnetic material of the magnetic recording medium manufactured using this method is smaller than that of the current recording medium. If there is a defective portion, therefore, the signal amplitude largely decreases and makes recording/reproduction operation difficult.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view of a bit patterned medium;

FIG. 2 is an exemplary view for explaining phase-difference servo;

FIG. 3 is a graph showing a servo signal in a servo pattern portion shown in FIG. 2;

FIG. 4 is an exemplary view showing dots arrayed into a servo pattern;

FIG. 5 is an exemplary view showing the way a self-organizing structure collapses;

FIGS. 6A and 6B are an exemplary view and graph showing a servo pattern array example and its servo signal;

FIGS. 7A and 7B are an exemplary view and graph showing a servo pattern array example and its servo signal;

FIGS. 8A and 8B are an exemplary view and graph showing a servo pattern array example and its servo signal;

FIGS. 9A and 9B are an exemplary view and graph showing regularly arrayed dot rows and their reproduction signal waveform;

FIGS. 10A and 10B are an exemplary view and graph showing randomly arranged dots and their reproduction signal waveform;

FIG. 11 is a graph showing a distribution of the PES (σPES) as a function of the distribution of dot position (σpos);

FIGS. 12A, 12B, 12C, and 12D are exemplary views showing a BPM pattern formation method;

FIG. 13 is a plan view showing the state of FIG. 12D;

FIG. 14 is an exemplary view showing the way a large number of dots gather in guide end portions;

FIG. 15 is an exemplary view showing a chemical guide;

FIG. 16 is an exemplary view showing the way self-organization is caused in PS-PDMS on the pattern shown in FIG. 15;

FIGS. 17A, 17B, 17C, and 17D are exemplary views showing a sidewall transfer process;

FIG. 18 is an exemplary plan view of the shape shown in FIG. 17D;

FIG. 19 is an exemplary view showing an example of a guide having inclined side surfaces;

FIG. 20 is an exemplary view showing design examples of a data dot pitch and guide pitch;

FIGS. 21A, 21B, 21C, 21D, 21E, and 21F are exemplary views showing the steps of manufacturing a pattern master and stamper according to an embodiment; and

FIGS. 22A, 22B, 22C, 22D, 22E, 22F, and 22G are exemplary views showing the steps of manufacturing a magnetic recording medium according to an embodiment.

### DETAILED DESCRIPTION

Various embodiments will be described hereinafter with reference to the accompanying drawings.

In general, a magnetic recording medium according to an embodiment includes a data area, and a servo area including a preamble portion, an address portion, and a burst portion, the burst portion having a belt-like magnetic dot pattern for a phase-difference detection method, and the burst portion magnetic dot pattern including a plurality of magnetic dots having a pattern formed by self-organization, wherein the density of magnetic dots in a peripheral portion of a central portion in a widthwise direction is higher than that of magnetic dots in the central portion.

The state in which the magnetic dot density in the peripheral portion of the central portion is higher includes a case in which the pitch of the magnetic dots is small, a case in which the magnetic dots partially overlap, and a case in which the magnetic dots come in contact with each other to form a continuous magnetic material.

A method of manufacturing a magnetic recording medium according to an embodiment includes the steps of forming, on a substrate, a guide of a self-organization in accordance with a belt-like pattern for a phase-difference detection method in a burst portion, applying a self-organizing material to the guide, and causing self-organization of the self-organizing material, thereby forming a self-organizing dot pattern, transferring the self-organizing dot pattern onto the surface of the substrate by etching the substrate by using the self-organizing dot pattern as a mask, thereby obtaining a master, and processing the surface of a magnetic recording layer in accordance with the self-organizing dot pattern on the master, thereby forming a belt-like magnetic dot pattern for the phase-difference detection method in the burst portion, wherein a resist pattern including a groove having a bottom surface and side surfaces is formed as the self-organizing pattern formation guide, and the bottom surface and side surfaces are hydrophobized or hydrophilized.

According to an aspect, the bottom surface and side surfaces can be hydrophobized.

According to another aspect, the side surfaces can have an inclination to the bottom surface.

According to still another aspect, the self-organizing dot pattern can have both a servo pattern and a data pattern by using a dot-like guide in the data dots area, where the pitch of the dot-like guide is multiples of that of a data dot.

Instead of forming the resist pattern including the groove having the bottom surface and side surfaces as the self-organizing pattern formation guide and hydrophobizing or hydrophilizing the bottom surface and side surfaces, it is possible to form a resist layer including a hydrophilic portion in a central portion in the widthwise direction, and a hydrophobic portion in a peripheral portion of the central portion.

A bit patterned medium (BPM) is a magnetic recording medium obtained by processing a continuous magnetic film into the shape of one bit, and is expected to increase the recording density of a hard disk drive (HDD) by eliminating the thermal stability problem in the present HDD medium made of a thin granular film.

FIG. 1 is an exemplary view of a bit patterned medium in which magnetic recording bits and servo patterns are arranged.

Data is recorded along the circumferential track of an HDD medium, and the track is divided into a plurality of portions 11 called sectors. Each sector includes a servo area 13, in which a head control signal is recorded, and a data area 12 made up of bit rows. The servo area further includes a plurality of burst portions (servo signal portions) having different functions. For example, as shown in FIG. 1, the servo signal area includes a preamble 16 for generating a sync signal for reproduction, an address portion 15 for generating an address signal indicating the location of data, and a servo signal portion 14 for generating a signal to control a head to be positioned appropriately on data rows. The servo signal shown in FIG. 1 has a form called phase-difference servo. In FIG. 1, reference numeral 17 denotes an area formed along the circumferential direction to place data rows. The area 17 is called a data track or simply called a track. Referring to FIG. 1, the track is indicated by the dotted lines in order to facilitate understanding.

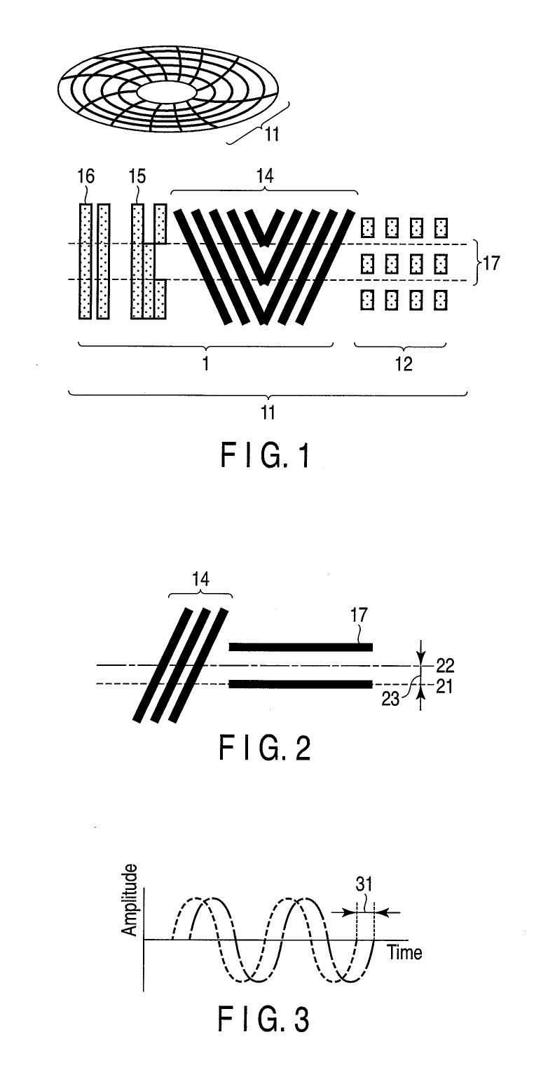

This embodiment is directed to a BPM in which the above-mentioned servo signal generating portion takes the form of phase-difference servo. The phase-difference servo is a method of generating a servo signal for positioning a head in an appropriate position on the track 17. An overview will be given below with reference to FIG. 2. As shown in FIG. 1, the phase-difference servo pattern includes a group of straight lines making a certain angle with the track direction, and these straight lines are placed parallel to each other. FIG. 2 is an exemplary view showing the relationship between the tracks and phase-difference servo pattern. Reference numeral 14 denotes a servo pattern, in which black lines indicate portions magnetized in one direction, e.g., upward, and white portions indicate portions magnetized in the opposite direction (downward) to the black lines. A dotted line 21 indicates the locus of a head when it runs just on the target track (on track). A one-dot dashed line 22 indicates the locus of the head when it runs off the target track with an offset amount 23.

FIG. 3 is a graph showing a servo signal when the head passes through the servo pattern portion 14 shown in FIG. 2.

The dotted line indicates a reproduced waveform in the on-track state (the dotted line) shown in FIG. 2. The one-dot dashed line indicates a servo signal waveform in the off-track state (the one-dot dashed line) shown in FIG. 2. When the head moves across the servo pattern portion, the upper and lower portions of magnetization regularly appear, consequently the signal waveform is a sine wave as shown in FIG. 3. If the head shifts by the offset amount 23, the phase of the waveform shifts by an offset amount 31. In phase-difference servo as described above, the offset amount of off track appears as a phase difference between the waveforms. A position error signal (PES) as an index for feeding back the head to an appropriate track position can be calculated based on this phase shift amount. This makes it possible to control the tracks to keep a predetermined phase difference.

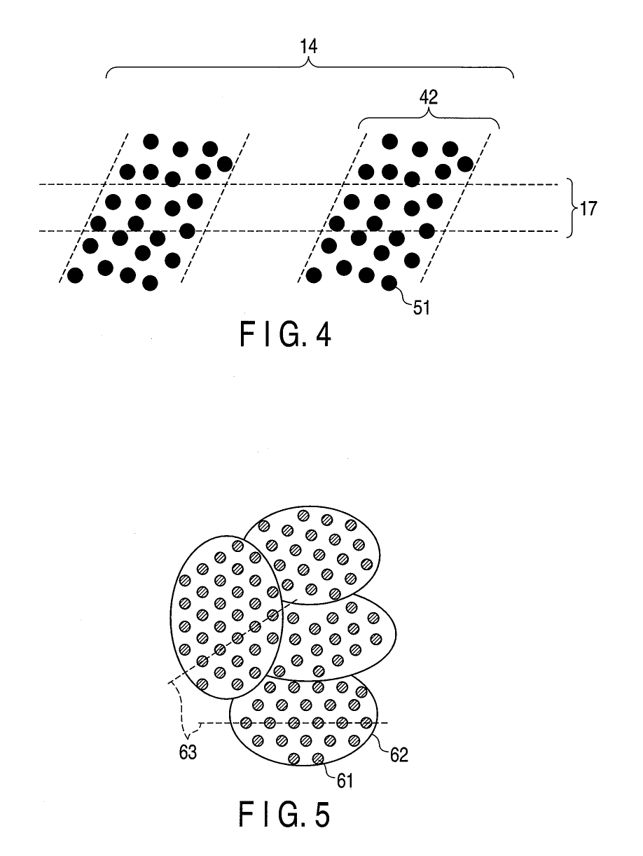

In this self-organizing BPM, the above-mentioned servo signal can be formed by using several methods. In one method, a self-organizing pattern is formed on the entire surface of the servo signal portion, and the servo signal is formed on the pattern by, e.g., nanoimprinting. In another method, the outer frame of a pattern of phase-difference servo or the like is formed, and self-organization is caused inside the frame. In either method, all arrayed dots form a servo pattern. FIG. 4 is an exemplary view showing such state.

Referring to FIG. 4, the servo signal is generated form areas 42 made up of rows of magnetic dots 51 and nonmagnetic portions between the areas 42. Amplitude of the reproduced signal from this servo signal portion fluctuates corresponding to the presence/absence of a dot. However, the overall waveform is generally similar to the one shown in FIG. 3 because there is a large change in the total magnetization between the dot areas 42 and the nonmagnetic areas. That is, the amplitude fluctuation corresponding to the presence/absence of a dot behaves as a noise of the servo signal. Even in this case, a proper servo signal, i.e., a PES can be obtained because it is generated by not the amplitude but the phase difference of the waveform as described before.

Unfortunately, the above-mentioned pattern formation method has the problem that the self-organizing structure collapses. The energy minimum state of the self-organization is a triangular lattice, in which dots are at equal distances. Since the self-organizing occurs everywhere almost simultaneously, a plurality of regions in which single triangular lattice is formed generate, and they form a region boundary. For comparison, FIG. 5 exemplarily shows the way the self-organizing structure collapses. Reference numeral 61 denotes a self-organizing dot; 63, the axis of the alignment of dot array; and 62, a domain made up of dots having the same array axis. When a servo pattern is formed by self-organization, it includes many domains and domain boundary in it. This situation results in a degradation of the servo signal quality.

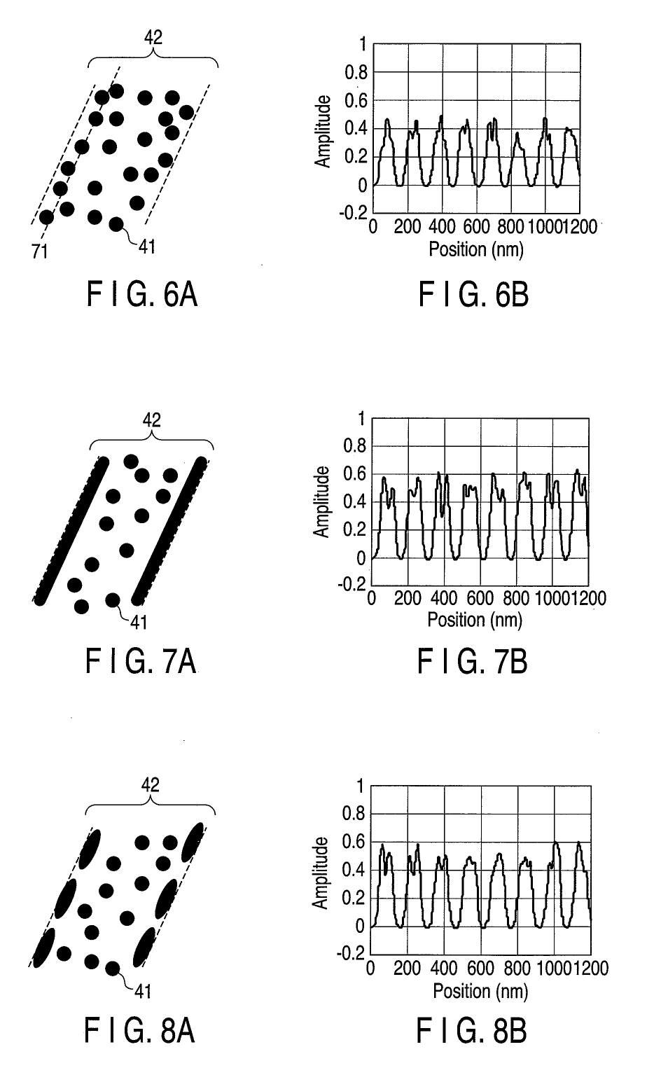

FIGS. 6A, 6B, 7A, 7B, 8A, and 8B are exemplary views and graphs showing servo pattern dot array examples in the burst portion and servo signals when a head passes through the servo pattern portion.

The BPM having this arrangement according to the embodiment is characterized in that the magnetic dot density in a peripheral portion of the servo track 42 is higher than that in a central portion of the servo track. As shown in the exemplary view of FIG. 6A, the density of dots along a straight line 71 in the peripheral portion is higher than that of dots in the central portion which is estimated similarly along the line moved to the central portion. The peripheral portion herein mentioned means a portion from the edge of a group of dots to a distance of about the size of a dot.

The dot density need only be high in the peripheral portion, regardless of the shape of a dot. For example, the density of a magnetic material (magnetic dots) in the peripheral portion can be higher than that in the central portion by having elliptic dots as shown in FIG. 8A.

As shown in the exemplary view of FIG. 7, the peripheral portion can also be a continuous magnetic material. In this case, the magnetic material need not continue over the entire servo signal, and need only be continuous when viewed from a read head. For example, magnetic dots can be formed as shown in FIG. 8A. The peripheral portion looks like a continuous magnetic material from a read head if the width of the read element in a head is smaller than the major axis of the ellipse. Consequently, the effect of the embodiment is obtained. The magnetic material need only continue over a length that is practically a few times to a few ten times larger than the dot in the central portion, although that depends on the width of a read element of a head.

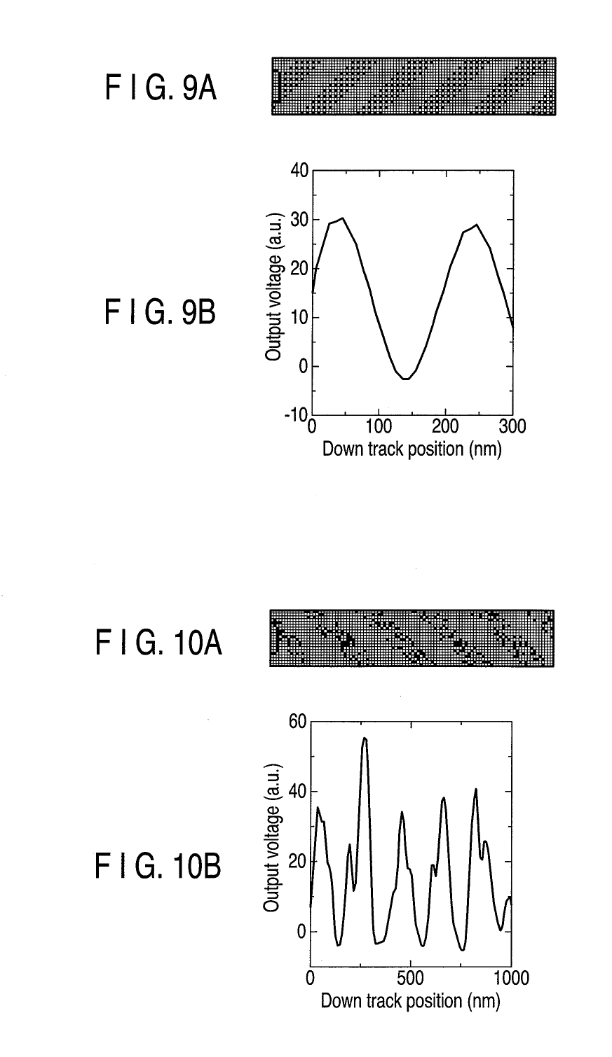

FIGS. 9A and 9B are an exemplary view and graph showing regularly arrayed dot rows and their reproduced signal waveform.

First, the reproduced signal waveform was calculated by the reciprocal theorem by using a model in which dot rows regularly arrayed within a phase-difference servo guide pattern. FIG. 9B shows the result.

FIG. 9A shows the magnetization pattern model used in the calculation. Magnetization was zero in white portions, and the saturation magnetization was 500 emu/cc in black portion. Each magnetic dot had a thickness of 10 nm, and had a square shape of 10 nm×10 nm. The width of a read element was 70 nm, and the distance from the head surface to the medium surface was 8 nm. A contour line at the left end of FIG. 9A indicates the sensitivity distribution of the read head.

FIG. 9B shows the reproduced waveform obtained by the calculation. The waveform is slightly square because the calculation steps are coarse, but is practically a sine waveform. Although the packing density of magnetic dots is as low as 25%, the servo signal is not problematic.

FIGS. 10A and 10B are an exemplary view and graph for the case in which dots do not ordered at all, i.e., they are placed at the random position. Since the dots exist at random as shown in FIG. 10A, the reproduced waveform shown in FIG. 10B is distorted having a large amplitude fluctuation. This result indicates that the servo signal quality presumably deteriorated.

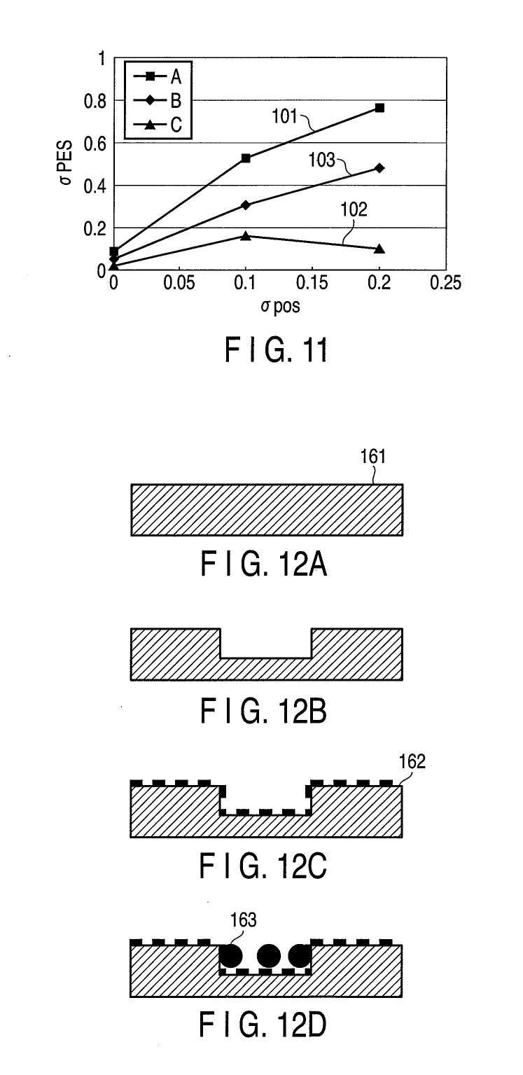

Subsequently, the PES was calculated from the calculated waveform in order to estimate a servo performance. This process is equivalent to a general method of calculating the PES from an ordinal phase-difference servo. FIG. 11 shows the results.

FIG. 11 is a graph showing a distribution of the PES (σPES) as a function of the distribution of dot position (σpos).

Referring to FIG. 11, the dot pitch is changed in the peripheral portion. Curves 101, 102, and 103 respectively correspond to the cases of FIGS. 6A, 7A and 8A. As the dot position variation σpos increases, the PES deteriorates and σPES increases as a whole. However, it is shown that the degradation in PES caused by the increase in σpos is suppressed in the order of A, B, and C, that is, in the order of the magnetic material filling ratio in the peripheral portion.

A method of manufacturing a magnetic recording medium according to another embodiment will be described below.

A general BPM manufacturing process by using a self-organizing mask can be used.

First, a base recording medium is manufactured by forming a perpendicular magnetic film on a glass substrate by sputtering or the like. As an example of the perpendicular magnetic film, an alloy containing Co and Pt is known as a magnetic material having a high anisotropic energy. A nonmagnetic underlayer for controlling the crystallinity and improving the adhesion or a so-called soft magnetic underlayer used in perpendicular magnetic recording may be formed below the perpendicular magnetic film. The magnetic layer itself may have a multilayered structure including a plurality of magnetic layers or nonmagnetic layers in order to improve the magnetic recording performance. A protective layer made of C or the like is generally stacked on the magnetic layer.

Then, the BPM pattern is formed. A desired pattern is formed on a resist layer on an Si substrate or the like by using electron-beam lithography and/or a self-organizing material, thereby manufacturing a master. The pattern can be a developed resist layer or can be formed by processing the Si substrate by using the resist as an etching mask. The feature of the bit patterned medium according to the embodiment is the pattern formation using self-organization, and this will be described in detail later.

Subsequently, a stamper is manufactured from the master. For example, a hard metal such as Ni is formed on the master by plating or the like, and then peeled off. The peeled Ni plate can be used as a stamper, or a resin plate transferred from the Ni stamper by injection molding or the like can be used as a stamper. It is also possible to use an Ni plate duplicated from the Ni stamper by plating as a stamper.

After that, an etching mask is formed on the base medium by nanoimprinting, by which the stamper is pushed against the resist layer on the base medium. It is possible to use, e.g., a room-temperature imprinting, by which the stamper is pushed against an SOG resist at a high pressure, a UV imprinting, by which the stamper is pushed against a UV-curing resin and UV light is irradiated on it, or a thermal imprinting using a heat-softening resin.

The magnetic layer is then etched by using the mask on the base medium. As this etching, it is possible to use ion milling, ion implantation, RIE (Reactive Ion Etching), or the like.

The processed structure is filled and planarized. Then, a protective layer is formed and lubricant layer is coated for a flying head. The planarization may include depositing an SiO₂ film and polishing it, or depositing a C film that also functions as a protective film. Preferable degree of planarization is equivalent to that of a substrate, but this requires a high cost. A planarization with a surface roughness that does not degrade the flyability of a recording head may be a solution.

The method of manufacturing the magnetic recording medium according to the embodiment has briefly been described above. Since the embodiment is directed to the technique of forming a BPM pattern by using a self-organizing material, other aspects of the method, such as the medium material and manufacturing process, are not particularly limited. The magnetic material can be a material other than a CoPt alloy, and can also be an in-plane magnetic film. Processing method can be selected in accordance with the specifications and purpose of the HDD system.

A method of forming a BPM pattern to be used in the magnetic recording medium according to the embodiment will be described below.

Typical self-organizing material is a PS-PDMS (polystyrene-polydimethylsiloxane) diblock copolymer. A PS block and a PDMS block have hydrophobic nature due to the molecular structure, and the hydrophobic nature of PDMS is stronger than that of PS. Therefore, the PDMS dot density can be increased at the guide edge portion by forming the guide with a hydrophobic material.

FIGS. 12A, 12B, 12C, and 12D are exemplary views showing the BPM pattern formation method.

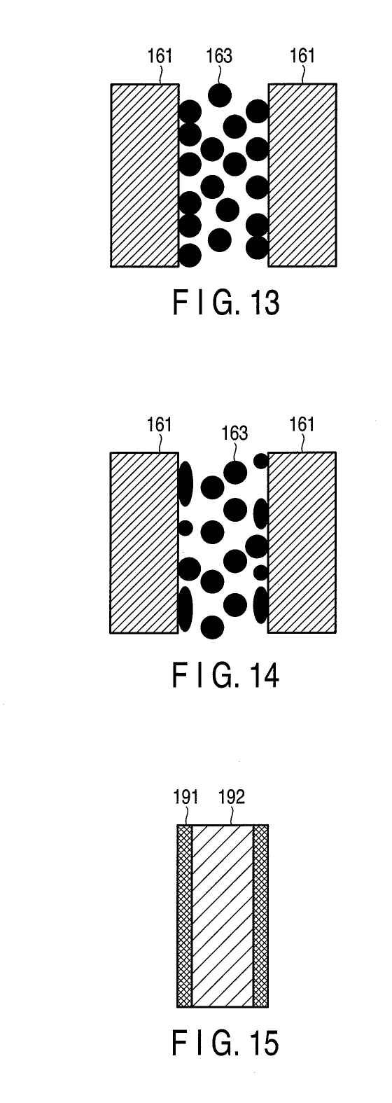

First, as shown in FIG. 12A, a substrate is coated with a resist layer 161 to form a servo guide. It is possible to use SOG (Spin-On-Glass) as the resist material. After that, a stamper having a guide structure is pushed against the resist to form a resist guide structure as shown in FIG. 12B. Then, a hydrophobizing process is applied to the resist layer as shown in FIG. 12C. Coating with HMDS (hexamethyldisilazane) can be used as this hydrophobizing process. In FIG. 12C, reference numeral 162 exemplarily indicates the surface having undergone the hydrophobizing process. A PS-PDMS material is coated on the guide with HMDS, and is annealed in a vacuum at 150° C. for 10 hrs to cause self-organization. FIG. 12D shows the resultant state. A PDMS dot 163 readily approaches the wall surface because the wall has the same hydrophobic nature. FIG. 13 is a plan view of the state shown in FIG. 12D. Many PDMS dots gather on the wall surfaces, and dots in the central portion tend to order themselves. In a BPM fabricated using this guide as a mask, the magnetic material density in the end portions of the guide is higher than that in the central portion. In case, the PDMS dots gathered at the end portions may form ellipses along the wall surfaces or may divide themselves into smaller dots.

FIG. 14 is an exemplary view showing the case where many dots gather in the guide end portions. The magnetic material density increases in the end portions in this case. Elliptic deformation can be increased by controlling the hydrophobic nature of the guide or adjusting the self-organization temperature. In this case, line-shape PDMS portions as shown in FIGS. 7A and 8A can be formed. The hydrophobizing process is generally applied to a smooth flat substrate, thereby improving the ordering of the self-organizing polymer (e.g., increasing the size of a domain). In a groove structure like that of this embodiment, however, no such hydrophobizing process is generally applied because disordering as shown in FIG. 14 occurs due to the adhesion of HMDS to the sidewalls. Even when the hydrophobizing process is applied, different materials are used in the sidewall portion and bottom portion of the guide so that the hydrophobizing process does not reach the sidewalls. Alternatively, the gathering of HMDS is prevented by lowering the sidewalls or making the taper angle of the sidewalls close to vertical. In this application, the thickness of the residue of the bottom surface portion of the groove is intentionally increased when pushing the stamper against SOG, and the bottom surface portion and sidewall portion are formed by the same material, so that HMDS sufficiently adheres to both the bottom surface and sidewalls. As described above, such a condition is not generally used because it leads to the disordered dot array.

An example of hydrophobization performed by the application of HMDS has been described above, but similar process can be applied by using a hydrophilizing process as well. That is, hydrophilizing the guide by UV irradiation or the like may result in the gathered PS dots at the guide end portions. Since the hydrophilizing process is also generally performed to improve the ordering of the dot array as described previously, this condition is not generally used as well.

Although an example of the hydrophobizing process using HMDS has been described above, the same effect can also be obtained by forming the guide by using a hydrophobic resin. An example of the hydrophobic resin is a UV-curing resin. In this case, a guide pattern need only be formed by using a UV-curing resin as the resist layer in FIGS. 12A, 12B, 12C, and 12D, and curing the resin by UV irradiation at the imprinting process. An example in which self-organization is caused within the UV-curing resin guide is known. In such a case, however, a material having affinity or no affinity to the self-organizing material for both the bottom portion and sidewall portion is not generally used in order to prevent disordering, as mentioned above.

Although the guide has a groove shape in the above-mentioned example, a chemical guide can also be used. As this chemical guide, there is a method that forms a small hydrophobic portion on a hydrophilic substrate. For example, the chemical guide is formed by spin-coating a substrate with a PS film, and partially removing the PS film by irradiating it with an electron beam via a mask.

FIG. 15 is an exemplary view showing the chemical guide.

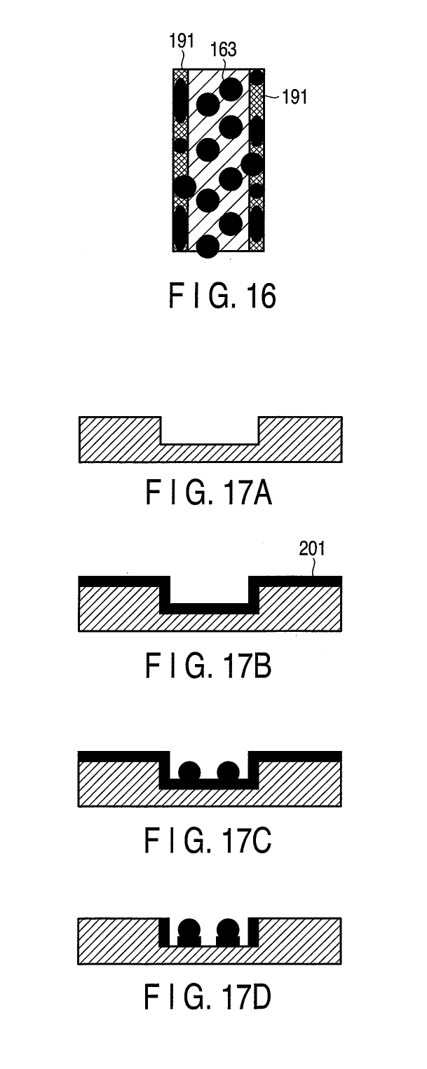

Reference numeral 192 denotes a PS portion applied on a substrate; and 191, a portion from which PS is removed. The portion 191 is relatively hydrophobic. FIG. 16 shows a state in which self-organization of PS-PDMS is caused on the pattern shown in FIG. 15. Many PDMS dots gather on the hydrophobic guide 191. When using the chemical guide as in this example, a general approach (to be described later as a data dot formation method) is to form the hydrophobic portions 191 as a dot shape at the position of the array period of the self-organizing material, that is, dots having almost the same size as self-organizing dots is formed and its period is an integral multiple of a desired triangular lattice. This approach improves the ordering quality. If a linear chemical guide as in this application is formed, disordering occurs as shown in FIG. 16. Therefore, no linear chemical guide is generally formed.

In addition to the above examples, there is also a method using a sidewall transfer process.

FIGS. 17A, 17B, 17C, and 17D are exemplary views showing the sidewall transfer process.

The process is the same as that shown in FIGS. 12A, 12B, 12C, and 12D up to the formation of a guide structure by using a resist such as SOG. After the guide is formed as shown in FIG. 17A, a material (sidewall material 201) such as C is deposited as shown in FIG. 17B. ALD (Atomic Layer Deposition), by which deposition on even the sidewall surfaces is possible, can be used as this deposition process. After that, as shown in FIG. 17C, self-organization is caused in the same manner as in FIG. 12D. Then, the PS matrix is etched out and expose the pattern bottom. In this step, the C layer below the PS matrix is also etched. Since this process removes the C film except for PDMS dots and sidewall portions, C layer has a shape shown in FIG. 17D. This C layer as well as PDMS dots are used as etching mask for the magnetic layer.

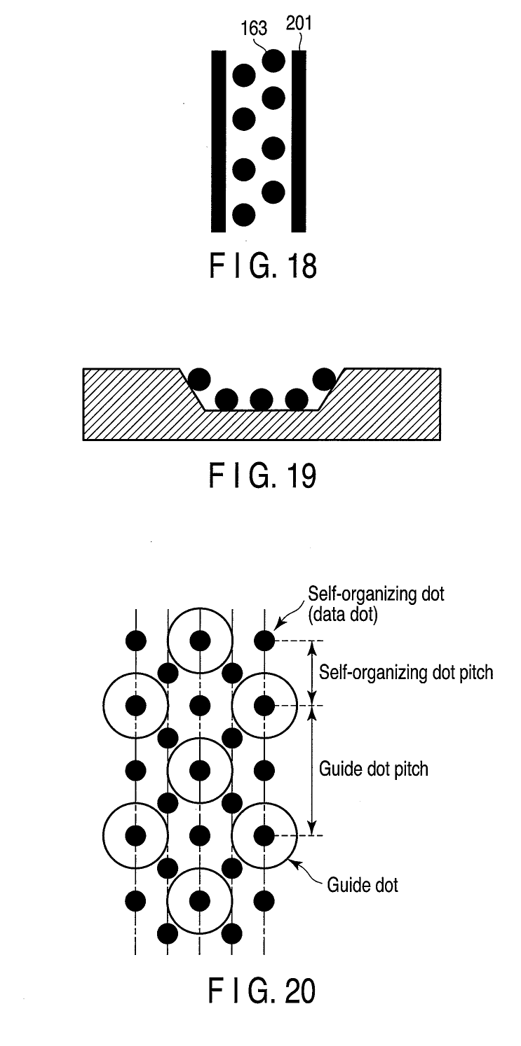

FIG. 18 is an exemplary plan view of FIG. 17D.

As shown in FIG. 18, line-shape magnetic material portions can be formed in the end portions of the servo guide by processing using this pattern. Generally, no guide portion is left behind as a pattern mask, because this portion remains as a magnetic material and hence cannot be used as a data portion of HDD. This portion also becomes a noise source. However, this embodiment uses the sidewall transfer technique to leave thin line-shape patterns at the sidewall positions of the guide pattern intentionally, thereby forming line-shape magnetic materials. This makes it possible to form a unique pattern in which only the end portions are disordered as shown in FIG. 18.

FIG. 19 is an exemplary view showing an example of a guide having inclined side surfaces.

A guide pattern shown in FIG. 19 can be fabricated by using a master with a guide pattern having inclined side surfaces. Such a guide pattern can be fabricated using an i-line resist material. Since the reactivity of the i-line resist decreases from the surface to the depth, an inclination corresponding to the distance from the surface can be formed. As shown in FIG. 19, the density of the magnetic dots on the guide edge can be increased by causing self-organization of the guide having this inclination. Generally, the inclination of the guide end can be as steep as possible because the self-organizing dots are raised on the guide end to cause disordering as shown in FIG. 19. In the example shown in FIG. 19, the inclination of the guide edge is formed at the end portion of the guide structure. However, the whole guide structure may have an inclined shape. In this case, the disordered structure reaches the central portion of the guide, but the end portions are disordered more. Consequently, the magnetic material density increases at the edge portion of the guide, and the bit patterned medium of this application can be manufactured.

The method of increasing the density of the magnetic material in the guide edge peripheral portion of a BPM servo pattern have been described above as the feature of this embodiment. On the other hand, all data dots must stably be arranged with a predetermined density.

FIG. 20 is an exemplary view showing design examples of the data dot pitch and the guide pitch for data dots.

As shown in FIG. 20, low-density dots are formed in alternate positions of data dots, and they become a guide for forming self-organized data dots. This data dot formation method can be used in combination with any of the various servo pattern formation methods as described above. Especially when using the chemical servo signal guide shown in FIG. 15, it is possible to simultaneously form the servo portion and data portion. The guide pitch is designed to be an integral multiple of the data dot pitch. In the example shown in FIG. 20, the data dot pitch is 17 nm, and the corresponding guide pitch is 34 nm, i.e., twice the data dot pitch. This condition makes the fabrication process of the data dot easier. As another method to form highly ordered data dots, causing self-organization in a recesses portion of a groove guide is possible. In this case, it is possible to use, e.g., the method of forming a portion having affinity to the self-organizing material in only the bottom portion, or the method of making the taper angle of the guide edge close to vertical, as described previously as a general method. Furthermore, the ordering can be improved by making the groove width almost equal to the dot array period. Alternatively, the ordering can be improved by forming a notch in a position matching the dot array period. In addition, it is possible to use any of various generally known array improving methods.

The embodiment can suppress deterioration of the servo signal quality (PES) when forming a phase-difference servo signal by self-organizing dots in the bit patterned medium.

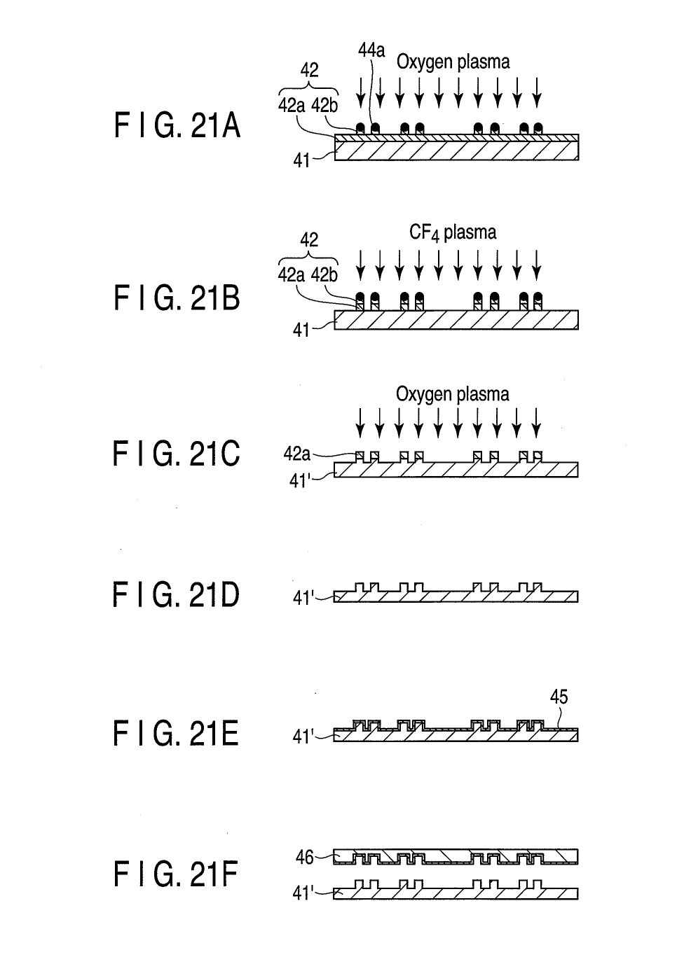

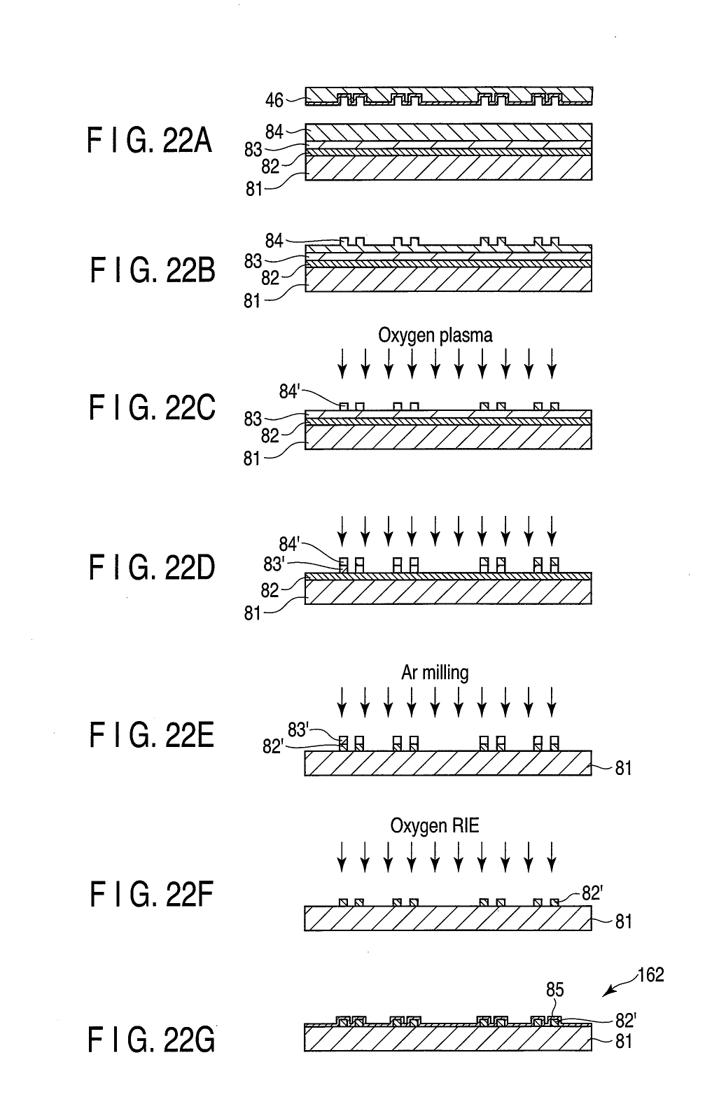

The post-process after FIG. 12D or 17D will be explained below with reference to FIGS. 21A, 21B, 21C, 21D, 21E, and 21F and 22A, 22B, 22C, 22D, 22E, 22F, and 22G.

FIGS. 21A, 21B, 21C, 21D, 21E, and 21F are exemplary views showing the steps of manufacturing the pattern master and stamper according to the embodiment.

FIGS. 22A, 22B, 22C, 22D, 22E, 22F, and 22G are exemplary views showing the steps of manufacturing the magnetic recording medium according to the embodiment.

FIG. 21A shows a state after selective removing of a 5-nm thick Si hard mask layer 42b of a hard mask layer 42 by CF₄ plasma etching (exposure was performed for 15 sec at 0.2 Pa, an antenna power of 50 W, and a coil power of 50 W) through a dot pattern as an etching mask. After that, oxygen plasma etching was performed (exposure was performed for 35 sec at 0.2 Pa, an antenna power of 100 W, and a coil power of 100 W) in order to etch a 15-nm thick C hard mask 42a below the Si hard mask. Consequently, the dot pattern was transferred onto the hard mask 42 as shown in FIG. 21B. Then, to transfer the dot pattern onto an Si substrate, CF₄ plasma etching was performed (exposure was performed for 30 sec at 0.2 Pa, an antenna power of 100 W, and a coil power of 100 W). As a consequence, the dot pattern was transferred onto a substrate 41 as shown in FIG. 21C. Finally, the residual C hard mask 42a was removed by oxygen plasma etching (exposure was performed for 40 sec at 0.2 Pa, an antenna power of 100 W, and a coil power of 100 W), thereby manufacturing a silicon stamper master 41′ as shown in FIG. 21D. When this master was observed with an atomic force microscope, the servo pattern had a structure in which the dot density in the peripheral portion of the central portion in the widthwise direction was higher than that in the central portion.

As shown in FIG. 21E, a thin conductive film 45 was formed on the silicon stamper master 41′ by sputtering. That is, in a chamber evacuated to 8×10⁻³ Pa and then adjusted to 0.5 Pa by supplying argon gas, sputtering was performed for 30 sec by using pure nickel as a target and applying a DC power of 100 W, thereby obtaining a 7-nm thick conductive film. Then, Ni was deposited on the conductive film by electroplating. The electroplating bath conditions were as follows.

Nickel sulfamate: 600 g/L

Boric acid: 40 g/L

Surfactant (sodium lauryl sulfate): 0.15 g/L

Solution temperature: 50° C.

pH: 4.0

Current density: 10 A/dm²

The thickness of the obtained Ni film was 300 μm. Subsequently, as shown in FIG. 21F, an Ni stamper 46 with the conductive film was formed by removing the deposited Ni film from the Si substrate.

Next, an example of the process of etching a magnetic layer for a bit patterned medium will be described.

As shown in FIG. 22A, a doughnut-like 1.8-inch glass substrate 81 is prepared. A magnetic recording layer 82 for perpendicular recording and a hard mask layer 83 for pattern transfer from a resist mask to the magnetic recording layer are deposited on the substrate. A resist layer 84 was formed by spin-coating with a novolak-based resist (S1801 available from Rohm and Haas) at a rotational speed of 3,800 rpm. The hard mask layer 83 is fabricated by stacking a 20-nm thick carbon layer and 5-nm thick Si layer from the substrate side. After that, the above-described stamper 46 was aligned with the substrate 81 to be processed. As shown in FIG. 22B, the stamper 46 was pressed at 2,000 bar for 1 min, thereby transferring the patterns onto the resist film 84. The resist layer 84 having the transferred patterns was irradiated with UV (ultraviolet) light for 5 min, and heated at 160° C. for 30 min. Then, as shown in FIG. 22C, an ICP (Inductively Coupled Plasma) etching apparatus was used to perform oxygen RIE, at an etching pressure of 2 mTorr, on the resist layer, thereby forming resist patterns 84′. Subsequently, the resist patterns 84′ were used as masks to form dot-like hard mask patterns 83′ as follows. First, a dot-like Si hard mask was formed by etching the upper Si layer of the hard mask layer at 0.1 Pa, an antenna power of 50 W, and a coil power of 10 W for 30 sec. Then, this Si layer was used as a hard mask to remove the lower C layer by performing oxygen plasma etching at 0.1 Pa, an antenna power of 200 W, and a coil power of 5 W for 40 sec, thereby forming the dot-like C hard mask patterns 83′ as shown in FIG. 22D.

The dot-like hard mask patterns 83′ were used as masks to etch the magnetic recording film 82 by using Ar ion milling, thereby forming an isolated dot-like magnetic recording layer 82′ as shown in FIG. 22E.

After that, as shown in FIG. 22F, oxygen RIE was performed at 400 W and 1 Torr in order to remove the dot-like hard mask patterns 83′ used as etching masks.

As shown in FIG. 22G, 3-nm thick DLC was deposited as a protective layer 85 on the substrate 81 and magnetic recording layer 82′ by CVD (Chemical Vapor Deposition).

Finally, a bit patterned medium 162 was obtained by coating the protective film 85 with a 1-nm thick lubricant (not shown) by dipping. Note that it is also possible to deposit DLC as a protective film after the magnetic recording layer 82a is formed and a nonmagnetic material such as SiO₂ is filled in the grooves by sputtering or the like. This method is favorable in that it is possible to adjust the planarization of the surface shape so as to stabilize the floating of a recording head.

The gist of this embodiment is to form the servo portion by using a self-organizing polymer. Accordingly, the post-process including stamper formation and magnetic material processing described above is merely an example, and it is possible to use various generally known patterned medium manufacturing methods.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium comprising:
a data area; and
a servo area comprising a preamble portion, an address portion, and a burst portion,
wherein the burst portion has a belt-like magnetic dot pattern for a phase-difference detection method, and
the magnetic dot pattern of the burst portion comprises a plurality of magnetic dots comprising a self-organized pattern, and a density of magnetic dots in a peripheral portion in a widthwise direction is higher than a density of magnetic dots in a central portion in the widthwise direction.

2. The medium of claim 1, wherein the magnetic dot pattern of the burst portion comprises a continuous magnetic material in the peripheral portion.

3. A method of manufacturing a magnetic recording medium comprising:
forming, on a substrate, a resist comprising a groove comprising a bottom surface and a side surface corresponding to a belt-like pattern for a phase-difference detection method in at least a burst portion;
forming a self-organizing pattern formation guide on the bottom surface and the side surface by either a hydrophobizing process or a hydrophilizing process;
applying a self-organizing material in the groove after the hydrophobizing process or the hydrophilizing process, and causing self-organization of the self-organizing material, thereby forming a self-organizing dot pattern;
transferring the self-organizing dot pattern onto a surface of the substrate by etching the substrate by using the self-organizing dot pattern as a mask, thereby obtaining a master; and
forming a stamper onto the surface where the self-organizing pattern is transferred based on the master, and patterning a surface of a magnetic recording layer in accordance with the self-organizing dot pattern by using the stamper, thereby forming a belt-like magnetic dot pattern for the phase-difference detection method in at least the burst portion.

4. The method of claim 3, further comprising hydrophobizing the bottom surface and the side surface.

5. The method of claim 3, wherein the side surface comprises a slope to the bottom surface.

6. The method of claim 3, wherein the self-organizing dot pattern comprises a servo pattern and a data pattern by using a dot-like guide in the data dots area, where the pitch of the dot-like guide is multiples of the pitch of a data dot.

7. A method of manufacturing a magnetic recording medium, comprising:
forming, on a substrate, a resist comprising a hydrophilic portion in a central portion in a widthwise direction and a hydrophobic portion in a peripheral portion of the central portion in accordance with a belt-like pattern for a phase-difference detection method in at least a burst portion;
forming a self-organizing pattern formation guide on the bottom surface and the side surface by either one of a hydrophobizing process or a hydrophilizing process;
applying a self-organizing material in the groove after the hydrophobizing process or the hydrophilizing process, and causing self-organization of the self-organizing material, thereby forming a self-organizing dot pattern;
transferring the self-organizing dot pattern onto a surface of the substrate by etching the substrate by using the self-organizing dot pattern as a mask, thereby obtaining a master; and
forming a stamper on the surface where the self-organizing pattern is transferred by using the master, and patterning a surface of a magnetic recording layer in accordance with the self-organizing dot pattern by using the stamper, thereby forming a belt-like magnetic dot pattern for the phase-difference detection method in at least the burst portion.

8. The method of claim 7, wherein the self-organizing dot pattern comprises a servo pattern and a data pattern by using a dot-like guide in the data dots area, where the pitch of the dot-like guide is multiples of the pitch of a data dot.
